(19) United States
(12) Patent Application Publication
(10) Pub. No.: US 2026/0366471 A1
(43) Pub. Date: Nov. 19, 2026

(54) EXHAUST GAS RECIRCULATION CIRCUIT WITH CONTROLLED EGR COOLING

(71) Applicant: Volvo Truck Corporation, GÖTEBORG (SE)

(72) Inventors: Daniel BERNHARDSSON, Göteborg (SE); Lars KALLRYD, Göteborg (SE)

(21) Appl. No.: 19/674,425

(22) Filed: May 12, 2026

(30) Foreign Application Priority Data
May 13, 2025 (EP) 25176174

(51) Int. Cl. F02M 26/23; F01N 13/10; F01P 7/14; F02M 26/16; F02M 26/17; F02M 26/33

(52) U.S. Cl. CPC F02M 26/23; F01N 13/10; F01P 7/14; F02M 26/16; F02M 26/17; F02M 26/33; F01P 2007/146; F01P 2025/13

(57) ABSTRACT

An exhaust gas recirculation (EGR) circuit of an internal combustion engine including an inlet and exhaust manifold is disclosed. The exhaust gas recirculation circuit includes an EGR mixer intended to be fluidically connected to the inlet manifold, and configured to be supplied with exhaust gas and air, an EGR pipe intended to fluidically connect the EGR mixer to the exhaust manifold, an EGR cooler mounted in the EGR pipe, intended to be supplied with exhaust gas, a coolant circuit passing through the EGR cooler, to operate a heat exchange between the exhaust gas and the coolant, and an EGR coolant valve mounted in the coolant circuit, configured to allow coolant flowing through the EGR cooler and prevent coolant from flowing through the EGR cooler.

### CROSS REFERENCE TO RELATED APPLICATIONS

This application claims priority to European Patent Application 25176174, filed on May 13, 2025, the disclosure and content of which is incorporated by reference herein in its entirety.

### TECHNICAL FIELD

The disclosure relates generally to an exhaust gas recirculation circuit for an engine, for example, but not limited to, of a vehicle. It concerns an exhaust gas recirculation circuit that can reduce NOx emissions of the internal combustion engine (ICE) of the vehicle through a cooled EGR strategy while enabling hot EGR flow under specific conditions. In particular aspects, the disclosure relates to an exhaust gas recirculation circuit with controlled EGR cooling. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

During the combustion process inside cylinders of an internal combustion engine (ICE), fuel and air are injected into the cylinders of the ICE and the combustion operating inside the cylinders enables to produce mechanical power intended to be transmitted, via a transmission line, from the output shaft of the ICE to the wheels to ensure the vehicle propulsion. The combustion consists in the chemical reaction inside the cylinder of fuel and dioxygen from the air, thereby forming main products such as water and carbon dioxide as well as unwanted pollutants such as soot and nitrogen oxides (NOx) emissions.

NOx are formed during the combustion process due to the presence of nitrogen in the air. Indeed, when high temperatures in the order of 1300 °C are reached, which is the case inside the cylinder, the nitrogen in the air recombines with the dioxygen to form chemical species such as NO and NO2, gathered under the denomination NOx emissions.

Emission standards have been introduced to limit the emission of pollutants into the atmosphere. In Europe, the emission standard is called Euro legislation. The disclosed technology aims at complying with the European emission requirement EU7, as well as the US requirements EPA27 and CARB27. These standards set maximum pollutant emission limits for new vehicles. There are several standards, depending on the type of vehicle. The standards evolve over time and become progressively stricter. Their aim is to reduce air pollution from road transport.

In order to reduce emissions of ICE, several measures are already taken and systems were developed in the past to limit soot and NOx emissions.

In order to reduce NOx emissions, cooled exhaust gas recirculation (EGR) circuits were introduced. Exhaust gas recirculation (EGR) is based on the redirection of a part of the exhaust gases from the exhaust manifold of the internal combustion engine through a liquid cooled EGR cooler into the intake manifold to reduce NOx emissions. This redirection of exhaust gases leads to a reduction of the combustion temperature inside the cylinder as the oxygen part is reduced. The EGR flow rate is controlled by an EGR valve controlled by a control unit of the ICE depending on the load and speed of the ICE. Thanks to the cooled EGR, a reduction of NOx formation is achieved.

In the EGR circuit, exhaust gas flows through the EGR cooler wherein heat exchange occurs between the exhaust gas and a coolant flowing through the EGR cooler. On its path through the EGR cooler, the coolant recovers thermal energy from the exhaust gas entering the EGR cooler. It results in cooled exhaust gas downstream of the EGR cooler.

The EGR flow rate control to meet a target value of EGR flow rate in the line from the exhaust manifold to the inlet manifold of the ICE is achieved by a cooled EGR valve placed in between. The cooled EGR valve is intended to redirect a part, for example, but not limited to, 10 to 20%, of the exhaust gas from the exhaust manifold to the inlet manifold. When the cooled EGR valve is fully open, this part of the exhaust gas passes through the line from the exhaust manifold to the inlet manifold. When the cooled EGR valve is fully closed, no exhaust gas passes through the line. Having the cooled EGR valve in a position between fully open and fully closed makes it possible to control the EGR flow rate in the line. In the prior art, this cooled EGR valve is mounted in the line between the exhaust manifold and the inlet manifold.

The EGR circuit is beneficial to the reduction of the NOx emissions as the cooled EGR introduced in the inlet manifold partly replaces fresh charge, thereby reducing the oxygen part entering the cylinders of the ICE. Decreasing available oxygen for combustion leads to lower combustion temperature, resulting in reduced NOx emissions. However, in some operating conditions, such as cold ambient temperatures or a too low coolant temperature, cooling EGR may have some negative impact on the proper operating of the EGR circuit and/or the ICE: the warmup of the ICE and/or reaching the temperature of an optimized operating of the exhaust aftertreatment system may take some time, ice may form in the EGR circuit, or the like.

Existing solutions proposed to bypass the EGR cooler. For that purpose, a bypass passage is mounted in parallel to the flow passage through the EGR cooler. An EGR cooler bypass valve is mounted downstream of the EGR cooled valve, so that the EGR cooler bypass valve directs the EGR flow towards the bypass passage when no cooled EGR is required. Doing so, the EGR flow does not take part to a heat exchange with the coolant. Even if it is satisfying, such a solution is cumbersome and can be quite complex to implement.

The disclosed technology falls within this context and proposes an EGR circuit allowing a controlled EGR cooling. It results in the providing of cooled EGR or hot EGR depending on the operating conditions. More particularly, the temperature of the EGR may be fine-tuned according to the transient requirements of the ICE.

The principle of the disclosed technology that will be described below may be applied within the framework of an Exhaust Aftertreatment System of any ICE that may produce NOx.

### SUMMARY

According to a first aspect of the disclosure, an exhaust gas recirculation circuit of an internal combustion engine comprising an inlet manifold and an exhaust manifold for collecting exhaust gas from the combustion in the internal combustion engine, said exhaust gas recirculation circuit being configured to evolve between a flowing configuration, in which exhaust gas is allowed to flow through it, and a closed configuration, in which the exhaust gas flow through it is prevented, and vice versa, said exhaust gas recirculation circuit comprises: An EGR mixer intended to be fluidically connected to the inlet manifold, and configured to be supplied with exhaust gas and air, and to mix them, An EGR pipe intended to fluidically connect the EGR mixer to the exhaust manifold, A first EGR valve configured to adjust the exhaust gas flow rate flowing from the exhaust manifold to the EGR mixer in the flowing configuration and to prevent the exhaust gas flow to the EGR mixer in the closed configuration,

An EGR cooler mounted in the EGR pipe, intended to be supplied with exhaust gas at an exhaust temperature from the exhaust manifold and to deliver exhaust gas at a target inlet temperature, A coolant circuit in which a coolant is intended to flow, said coolant circuit passing through the EGR cooler, so as to operate a heat exchange between the exhaust gas and the coolant, An EGR coolant valve mounted in the coolant circuit, said EGR coolant valve being configured to switch between an open position in which coolant can flow through the EGR cooler to a shut-off position in which coolant is prevented from flowing through the EGR cooler.

The exhaust gas recirculation circuit is able to be in a flowing configuration, in which exhaust gas is allowed to flow through it. In this configuration, the first EGR valve is at least partly open to let exhaust gas from the exhaust manifold flow in the EGR pipe towards the EGR mixer. There is an exhaust gas recirculation. As the EGR cooler is mounted in the EGR pipe, the exhaust gas flowing through the EGR pipe crosses the EGR cooler. At the outlet of the EGR cooler, the exhaust gas is cooled, its temperature is the target inlet temperature for entering the EGR mixer.

The exhaust gas recirculation circuit is also able to be in a closed configuration, in which the exhaust gas flow through it is prevented. In this configuration, the first EGR valve is closed, and no exhaust gas can flow from the exhaust manifold through the EGR pipe. There is no exhaust gas recirculation.

In this document, and unless otherwise indicated, the exhaust gas refers to the exhaust gas circulating in the exhaust gas recirculation circuit. That is to say, when no further indication is given, the exhaust gas means the part of exhaust gas from the exhaust manifold passing through the first EGR valve and directed in the EGR pipe towards the EGR mixer.

In the flowing configuration, the exhaust gas from the exhaust manifold enters the EGR cooler at an inlet port of the EGR cooler at a temperature being denominated exhaust temperature. At an outlet port of the EGR cooler, the exhaust gas leaves the EGR cooler cooled down to a target inlet temperature being less than the exhaust temperature.

The cooling of the exhaust gas is performed inside the EGR cooler thanks to the coolant circuit. A coolant flows through the coolant circuit. The coolant circuit extends partially inside the EGR cooler, either according to an internal duct or along a plurality of ducts branches, or according to any other patterns. In other words, the EGR cooler is a heat exchanger inside which a heat exchange operates between the exhaust gas and the coolant. During the heat exchange, thermal energy of the (hot) exhaust gas at exhaust temperature is transferred to the (fresh) coolant. Further to this heat transfer, the temperature of the exhaust gas decreases, while the temperature of the coolant increases. The exhaust gas leaves the EGR cooler at the outlet port at a lower temperature than the exhaust temperature. The operating of the EGR cooler and the coolant circuit is such that the temperature of the exhaust gas at the outlet port of the EGR cooler can be controlled so that it is the target inlet temperature. As the coolant recovers thermal energy inside the EGR cooler, the coolant leaves the EGR cooler at a higher temperature than the temperature it has before entering the EGR cooler. Even if not further described in this document, the coolant circuit further comprises at least one element having the role of cooling the coolant, so that it can further flow at low temperature inside the EGR cooler.

An EGR coolant valve is mounted in the coolant circuit. The EGR coolant valve can evolve between an open position and a shut-off position. In its open position, the coolant flows through the coolant circuit as described above. In its shut-off position, the coolant cannot flow through the coolant circuit. The EGR coolant valve can also take any position in between, that is to say that the EGR coolant valve can be partly open. When partly open, the flow rate of the coolant flowing in the coolant circuit is reduced compared to the fully open configuration.

The EGR coolant valve makes it possible to stop the flow of coolant flowing into the EGR cooler. As a consequence, when the EGR coolant valve is in its shut-off position, no coolant flows inside the EGR cooler. The exhaust gas circulates through the EGR cooler that is, at least temporarily, not provided with coolant. The exhaust gas is not cooled by the coolant inside the EGR cooler. When leaving the EGR cooler, the exhaust gas still has a temperature being the exhaust temperature (or a temperature being almost the same as the exhaust temperature, for example from 0,8 to 1,0 time the exhaust temperature, due to the slight heat loss that may occur in the EGR pipe upstream of the EGR cooler). In this configuration, the EGR mixer is not provided with cooled recirculated exhaust gas. Instead, it is provided with hot recirculated exhaust gas.

The disclosed technology aims at providing hot recirculated exhaust gas. There are many benefits such as preventing or reducing the risk of ice formation in the exhaust gas recirculation circuit when ambient temperatures are very low. Also, under such ambient conditions, the recirculation of hot exhaust gas avoids, or at least reduces, the risk of condensation in the EGR pipe and EGR cooler during cold starts. Another advantage of hot recirculated exhaust gas is the acceleration of the engine warmup. As the recirculated exhaust gas is hot, the mixture of air and exhaust gas entering the inlet manifold, and thus the cylinders of the engine, is at a higher temperature (in comparison to a case with cooled recirculated exhaust gas). The resulting combustion temperature inside the cylinders is also higher than it would be with cooled recirculated exhaust gas. The internal combustion engine rises fast and reaches its optimum operating temperature in a short time. The available heat can be dispatched to other elements requiring heat, for example the cabin or passenger compartment. The exhaust aftertreatment system warmup is also accelerated. It can therefore work more quickly according to its optimum operating conditions, thereby rendering it more efficient to process pollutants. Another advantage due to the hot mixture entering the cylinders can be mentioned. This charge air having a certain temperature level, it has an impact on the ignition delay time as the in-cylinder temperature is one of the main parameters that drive the ignition. Enabling hot recirculated exhaust gas typically reduces the ignition delay time. In the complex combustion process, an early ignition may result in some conditions to an improvement of the combustion efficiency, leading to a reduction of soot, HC (hydrocarbons) and CO (carbon monoxide) emissions.

In the disclosed technology, the hot recirculated exhaust gas is obtained in a particular way. Thanks to the EGR coolant valve controlling the flow of the coolant in the coolant circuit, the exhaust gas flow is not disturbed. It is to be understood that whatever the target temperature (i.e. hot or cooled) of the recirculated exhaust gas, the exhaust gas still flows through the EGR cooler. The target temperature of the recirculated exhaust gas is driven by the flow of the coolant. In other words, differently from solutions of the prior art, the recirculated exhaust gas does not bypass the EGR cooler. Exhaust gas still flows through the EGR cooler. It is the coolant that is prevented from flowing through the EGR cooler. On top of being of a quite simple arrangement, such a solution is safe as the EGR coolant valve is on the coolant circuit, that is to say it is not mounted in a hot environment.

The EGR coolant valve may be for example a butterfly valve. A butterfly valve is easy to control, as it does not require a high control force to be actuated.

In some embodiments, the EGR coolant valve is mounted upstream of the EGR cooler. In such a configuration, the EGR coolant valve can stop the flow of coolant intended to enter the EGR cooler. No fresh coolant can reach the EGR cooler.

In some embodiments, the EGR coolant valve is mounted downstream of the EGR cooler. In such a configuration, the EGR coolant valve can stop the flow of coolant intended to leave the EGR cooler. And no further fresh coolant can reach the EGR cooler as long as the EGR coolant valve is in its shut-off position.

In some embodiments, the coolant circuit comprises a bypass line bypassing the EGR cooler. In such a configuration, the EGR coolant valve is mounted so as to prevent the coolant flow inside the EGR cooler and to redirect the coolant flow in the bypass line. It is also possible, according to an intermediate aperture of the EGR coolant valve, to allow a first part of the coolant flow to flow in the EGR cooler and a second part of the coolant flow to bypass the EGR cooler. It results in a least cooling of the exhaust gas inside the EGR cooler.

In some embodiments, the exhaust gas recirculation circuit further comprises processing circuitry configured to receive an input signal and send a command to the EGR coolant valve to switch to the shut-off position if the input signal is below a predefined threshold.

The processing circuitry is configured to control various parameters of the exhaust gas recirculation circuit. Namely the processing circuitry is configured to receive signals indicative of the state of the internal combustion engine and/or the exhaust gas recirculation circuit and send commands to at least the actuators of the EGR coolant valve to make the exhaust gas recirculation circuit and/or the internal combustion engine operate according to instructions that may be stored on the processing circuitry or on a remote memory and in communication with the processing circuitry.

In some embodiments, the input signal is a measured ambient air temperature, and the predefined threshold is an air temperature threshold. When the measured ambient air temperature is lower than the air temperature threshold, which is indicative of low temperature conditions, the processing circuitry may be configured to send to the EGR coolant valve the command of switching into its shut-off position to achieve hot recirculated gas.

In some embodiments, the input signal is a measured coolant temperature, and the predefined threshold is a coolant temperature threshold. When the measured coolant temperature is lower than the coolant temperature threshold, which is indicative of low temperature conditions and/or a too cold coolant, the processing circuitry may be configured to send to the EGR coolant valve the command of switching into its shut-off position to avoid too cooled exhaust gas, that is to say recirculated exhaust gas having a temperature lower than the target inlet temperature. Indeed, too cooled exhaust gas could have a negative impact on the combustion process.

In some embodiments, the input signal is a measured intake manifold temperature, and the predefined threshold is an intake manifold temperature threshold. When the measured intake manifold temperature is lower than the intake manifold threshold, which is indicative of a too cold air mixture intended to enter the cylinders, the processing circuitry may be configured to send to the EGR coolant valve the command of switching into its shut-off position to stop the cooling of the exhaust gas.

In some embodiments, the exhaust gas recirculation circuit further comprises a bypass pipe intended to fluidically connect the exhaust manifold to the EGR pipe downstream of the EGR cooler, and a second EGR valve configured to adjust the exhaust gas flow rate flowing in the bypass pipe.

The bypass pipe forms an additional route for the exhaust gas to recirculate back to the inlet manifold without being cooled down by the EGR cooler. Exhaust gas flowing through the bypass pipe flows from the exhaust manifold to the EGR mixer. When the second EGR valve is open, hot exhaust gas flows in the bypass pipe towards the EGR mixer. It enables to provide the EGR mixer with recirculated exhaust gas at the exhaust temperature. It may be noted that the second EGR valve can be actuated independently from the first EGR valve.

According to a second aspect of the disclosure, an internal combustion engine comprises an inlet manifold, an exhaust manifold for collecting exhaust gas from the combustion in the internal combustion engine, and an exhaust system comprising: an exhaust gas recirculation circuit as described in this document, an exhaust aftertreatment system intended to process pollutants contained in the exhaust gas, an exhaust line fluidically connecting the exhaust manifold to the exhaust aftertreatment system.

In some embodiments, the internal combustion engine further comprises an ambient air temperature sensor configured to measure ambient air temperature.

In some embodiments, the internal combustion engine further comprises a coolant temperature sensor configured to measure a coolant temperature in the coolant circuit.

In some embodiments, the internal combustion engine further comprises an intake manifold temperature sensor configured to measure a temperature inside the intake manifold.

The internal combustion engine according to the disclosed technology as described above further exhibits advantages similar to those of the exhaust gas recirculation circuit according to the disclosed technology. Other technical effects and advantages will be detailed in the description of the figures.

According to a third aspect of the disclosure, a vehicle comprises such an internal combustion engine.

The disclosed aspects, examples, and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

Examples are described in more detail below with reference to the appended drawings.

FIG. 1 is a perspective view of an exemplary of a vehicle equipped with an internal combustion engine and an exhaust gas recirculation circuit according to an example.

FIG. 2 is a schematic diagram showing an exemplary exhaust gas recirculation circuit according to an example.

FIG. 3 is a schematic diagram showing an exemplary exhaust gas recirculation circuit according to an example.

FIG. 4 is a schematic diagram showing an exemplary exhaust gas recirculation circuit according to an example.

FIG. 5 is a schematic diagram showing an exemplary exhaust gas recirculation circuit according to an example.

### DETAILED DESCRIPTION

The detailed description set forth below provides information and examples of the disclosed technology with sufficient detail to enable those skilled in the art to practice the disclosure.

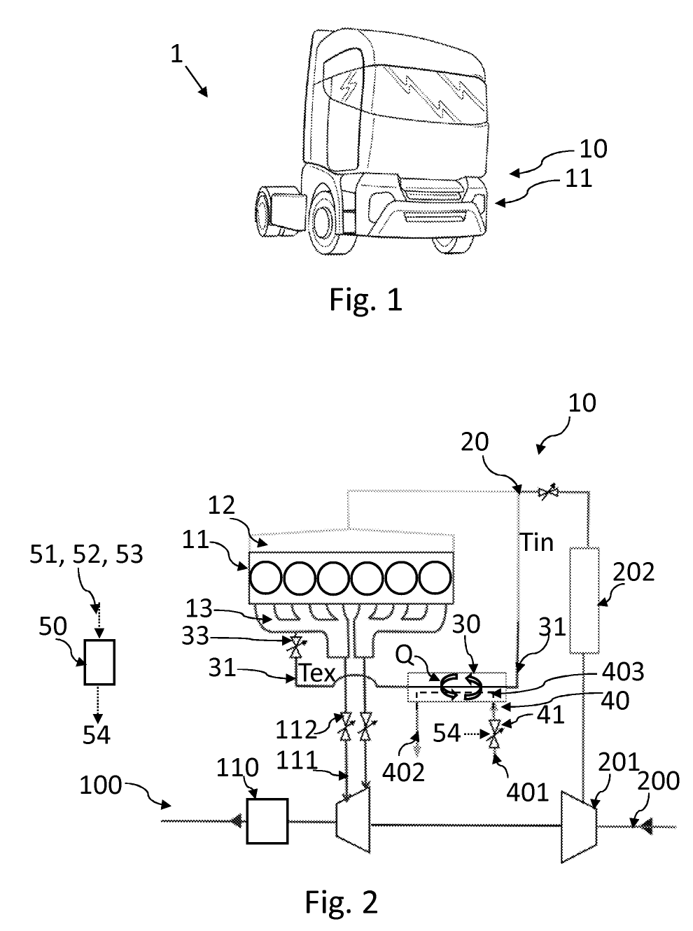

FIG. 1 is a perspective view of an exemplary of a vehicle 1 equipped with an internal combustion engine 11 and an exhaust gas recirculation circuit 10 according to an example. As illustrated, vehicle 1 is a truck. Nevertheless, the method according to the disclosed technology may be applied to any internal combustion engine and exhaust gas recirculation circuit, and the vehicle may be any vehicle, for example a bus or a car.

FIG. 2 is a schematic diagram showing an exemplary exhaust gas recirculation circuit according to an example. In FIG. 2, an internal combustion engine 11 is schematically represented. The internal combustion engine 11 comprises a plurality of cylinders. As an example, the internal combustion engine is a 6-cylinder in line engine. This arrangement is an example of an engine to which the disclosed technology can be applied. But the scope of the disclosed technology is not limited to this kind of engine and can be applied to any other type of internal combustion engine, whatever the number of cylinders and their disposition in relation to each other are.

The internal combustion engine 11 comprises an inlet manifold 12 and an exhaust manifold 13. The inlet manifold is configured to receive air to be provided to the cylinders of the internal combustion engine 11. When operating, the internal combustion engine 11 receives air from the inlet manifold 12, fuel is injected into the cylinders. Combustion occurs inside the cylinders, thereby enabling to produce mechanical power intended to be transmitted, via a transmission line, from the output shaft of the internal combustion engine to the wheels to ensure the vehicle propulsion. The combustion consists of the chemical reaction inside the cylinder of fuel and dioxygen from the air, thereby forming main products such as water and carbon dioxide as well as unwanted pollutants such as soot and nitrogen oxides (NOx) emissions.

The exhaust manifold 13 collects the exhaust gas from the combustion inside the cylinders of the internal combustion engine 11.

The internal combustion engine 11 also comprises an exhaust system 100 comprising an exhaust gas recirculation circuit 10 that will be described in detail below. The exhaust system 100 further comprises an exhaust aftertreatment system 110 intended to process pollutants contained in the exhaust gas, an exhaust line 111 fluidically connecting the exhaust manifold 13 to the exhaust aftertreatment system 110, and processing circuitry 50 configured to send signals to the exhaust gas recirculation circuit 10 depending on the operation of the internal combustion engine 11.

The exhaust aftertreatment system 110 will not be described in detail as it comprises aftertreatment elements known in the prior art, such as a particle filter to physically catch the soot particles emitted by the internal combustion engine 11 during phases of the combustion process wherein the combustion is not taking place as a complete combustion, and eventually a SCR system (selective catalyst reduction) to transform remaining NOx in the exhaust gas flowing in the exhaust line 111 into N2 and H2O.

The exhaust gas recirculation circuit 10 of the disclosed technology will now be described in detail. The exhaust gas recirculation circuit 10 is configured to evolve between a flowing configuration, in which exhaust gas is allowed to flow through it, and a closed configuration, in which the exhaust gas flow through it is prevented, and vice versa. In other words, in the flowing configuration, exhaust gas can flow through the exhaust gas recirculation circuit 10, and in the closed configuration, exhaust gas cannot flow through the exhaust gas recirculation circuit 10. The exhaust gas recirculation circuit 10 may switch from the flowing configuration to the closed configuration and it may also switch from the closed configuration to the flowing configuration.

The exhaust gas recirculation circuit 10 comprises an EGR mixer 20 intended to be fluidically connected to the inlet manifold 12, and configured to be supplied with exhaust gas and air, and to mix them. The internal combustion engine 11 comprises an air inlet 200 to provide air to the cylinders. The air from the air inlet 200 goes through a compressor 201 before entering a charge air cooler 202. The outlet of the charge air cooler 202 is fluidically connected to the EGR mixer 20. This constitutes the air providing line.

The exhaust gas recirculation circuit 10 comprises an EGR pipe 31 intended to fluidically connect the EGR mixer 20 to the exhaust manifold 13.

The exhaust gas recirculation circuit 10 further comprises a first EGR valve 33 configured to adjust the exhaust gas flow rate flowing from the exhaust manifold 13 to the EGR mixer 20 in the flowing configuration and to prevent the exhaust gas flow to the EGR mixer 20 in the closed configuration.

The exhaust gas recirculation circuit 10 also comprises an EGR cooler 30 mounted in the EGR pipe 31, intended to be supplied with exhaust gas at an exhaust temperature Tex from the exhaust manifold 13 and to deliver exhaust gas at a target inlet temperature Tin. In other words, the role of the EGR cooler 30 is to reduce the temperature of the exhaust gas from Tex down to Tin. It is to be understood that the EGR pipe 31 extends upstream of the EGR cooler 30 from the exhaust manifold 13 to an inlet port of the EGR cooler 30 and downstream of the EGR cooler 30 from an outlet port of the EGR cooler 30 to an inlet of the EGR mixer 20. It results that the exhaust gas flowing through the EGR cooler 30 mixes with the air flowing through the air providing line in the EGR mixer 20, to form a mixture of air and exhaust gas. The EGR mixer 20 may have any form that enables the mixture of air and exhaust gas. It may be a simple pipe to which the EGR pipe 31 and the air providing line are fluidically connected, or it may be a mixer having a dedicated volume to enable air and exhaust gas to mix before entering the pipe fluidically connected to the inlet manifold 12.

Following what was described above, it appears clear that exhaust gas is produced during combustion and is collected in the exhaust manifold 13. The exhaust gas temperature exiting the exhaust manifold 13 is Tex. The main part of the exhaust gas flows towards the exhaust line 111, they usually pass through a turbine to reach the exhaust aftertreatment system 110 where they are treated in order to remove NOx and soot. Further to the at least partially opening of the first EGR valve 33, a part of the exhaust gas in the exhaust manifold 13 is directed through the exhaust gas recirculation circuit 10. This part of the exhaust gas flows through the EGR pipe 31 to enter the EGR cooler 30 where the temperature of the exhaust gas decreases from Tex to Tin. The exhaust gas leaves the EGR cooler 30 and flows further through the EGR pipe 31 toward the EGR mixer 20, where it is mixed with fresh air coming from the air inlet. The mixture of fresh air and exhaust gas is directed to the inlet manifold 12. The part of the exhaust gas that recirculates towards the inlet manifold is therefore cooled in the EGR cooler 30, for example a liquid cooled EGR cooler. The recirculation of the cooled exhaust gas results in the reduction of the ratio of dioxygen entering the cylinders, thereby leading to lower combustion temperatures. The level of NOx emitted during combustion is lower.

The exhaust gas recirculation circuit 10 comprises a coolant circuit 40 in which a coolant is intended to flow, said coolant circuit passing through the EGR cooler 30, so as to operate a heat exchange Q between the exhaust gas and the coolant. The coolant circuit 40 comprises a first duct 401 through which fresh coolant is flowing toward the EGR cooler 30 and a second duct 402 through which heated coolant is flowing out of the EGR cooler 30. The coolant circuit 40 further comprises an internal duct 403 fluidically connected to the first and second ducts 401, 402 extending inside the EGR cooler 30. The coolant flowing in the first duct 401 has a temperature lower than the exhaust gas temperature Tex. In some embodiments, its temperature is about the target inlet temperature Tin, or even lower. Consequently, the exhaust gas flowing through the EGR cooler 30 enters the EGR cooler 30 at a temperature being Tex. The EGR cooler 30 is a volume in which heat exchange occurs between the hot exhaust gas and the fresh coolant. The exhaust gas transfers thermal energy Q to the coolant flowing through the internal duct 403. The coolant is heated whereas the exhaust gas is cooled from Tex to the target inlet temperature Tin.

As depicted in the figures, the EGR cooler 30 is schematically represented as a volume with two ducts in the form of a tubular heat exchanger: the EGR pipe 31 in which the exhaust gas flows and the internal duct 403 in which the coolant flows. Nevertheless, the disclosed technology is not limited to such an arrangement and any other type of EGR cooler is a possible variant. For example, the EGR cooler 30 can be a plate heat exchanger or a coaxial coil heat exchanger, a finned tube heat exchanger. The disclosed technology requires separate flows of coolant and exhaust gas inside the EGR cooler 30, whatever the interleaving of both flows is, provided that a heat exchange operates between the exhaust gas and the coolant without mixing them.

The exhaust gas recirculation circuit 10 comprises an EGR coolant valve 41 mounted in the coolant circuit 40. The EGR coolant valve 41 is configured to switch between an open position in which the coolant can flow through the EGR cooler 30 to a shut-off position in which the coolant is prevented from flowing through the EGR cooler 30.

The EGR coolant valve 41 can switch between the open position and the shut-off position, which means that the EGR coolant valve 41 can take any position between a fully open position and a fully closed position. In other words, the degree of aperture of the EGR coolant valve 41 can vary according to a request for cooling the exhaust gas in the EGR cooler 30 that will be described below.

In the open position, the EGR coolant valve 41 allows the coolant to flow through the EGR cooler 30 as described above. The predefined coolant flow allowing the exhaust gas temperature to enter the EGR cooler 30 at Tex to be cooled down to the target inlet temperature Tin circulates through the EGR cooler 30.

In the shut-off position, the EGR coolant valve 41 prevents the coolant to flow through the EGR cooler 30. The exhaust gas entering the EGR cooler 30 at the exhaust gas temperature Tex leaves the EGR cooler 30 at the same exhaust gas temperature. No heat exchange occurs in the EGR cooler 30 as no coolant flows through it. As a consequence, the exhaust gas supplying the EGR mixer 20 is at the exhaust gas temperature, i.e. it is not a cooled exhaust gas. Instead, exhaust gas at exhaust gas temperature recirculates towards the EGR mixer 20 where it is mixed with air and directed towards the inlet manifold 12.

As already mentioned, the EGR coolant valve 41 can also be actuated in a position between fully closed and fully open. For example, the EGR coolant valve 41 can be half open (or half closed). In such a case, the degree of aperture of the EGR coolant valve 41 is 50%. It means that the coolant flow rate flowing through the EGR cooler 30 is half the nominal flow of a fully open EGR coolant valve 41. Similarly, the EGR coolant valve 41 can be open at 20%, 30%, or 75%. It is to be understood that the degree of aperture of the EGR coolant valve 41 determines the coolant flow rate inside the EGR cooler 30, and hence the level of heat exchange that is made possible inside the EGR cooler 30 between the coolant and the hot exhaust gas.

In a shut-off position of the EGR coolant valve 41, or at least in a partially open position, the exhaust gas leaving the EGR cooler 30 is not cooled to the target inlet temperature Tin. In a shut-off position of the EGR coolant valve 41, the exhaust gas leaving the EGR cooler still has its exhaust gas temperature Tex. It corresponds to a situation in which the exhaust gas flowing through the exhaust gas recirculation circuit is not cooled. It results in an exhaust gas recirculation strategy in which hot exhaust gas is allowed to reach the inlet manifold.

Such a strategy presents several technical benefits to set the EGR coolant valve to its shut-off position. In case of cold ambient temperatures, hot recirculated exhaust gas reduces the risk of ice formation in the exhaust gas recirculation circuit, as only hot exhaust gas flows through the EGR pipe 31. Similarly, hot exhaust gas flowing in the EGR cooler and the EGR pipe significantly reduces the risk of condensation in the EGR pipe and EGR cooler during cold starts. During the engine warmup, the recirculation of hot exhaust gas ensures that the engine reaches its optimum operating temperature very quickly thanks to the hot exhaust gas part of the mixture of air and exhaust gas entering the inlet manifold. It results also in the acceleration of the exhaust aftertreatment system warmup. Once its optimum operating conditions are reached, the exhaust aftertreatment system is able to process pollutants in an efficient manner. The EGR coolant valve in the shut-off position leads to a mixture of air and recirculated exhaust gas having a higher temperature than it would have with cooled EGR. It results in the reduction of the ignition delay time of combustion occurring in each cylinder of the engine. Depending on the variation of the ignition delay time, the combustion process may be improved, so as to generate less pollutants (soot, HC (hydrocarbons) and CO (carbon monoxide)).

The disclosed technology makes it possible to provide either cooled exhaust gas to the EGR mixer 20 (in which case the EGR coolant valve 41 is open) or hot exhaust gas (in which case the EGR coolant valve 41 is closed, or in its shut-off position).

The disclosed technology presents a particular arrangement in that the hot exhaust gas is obtained by preventing the coolant flow inside the EGR cooler 30 (or at least allow the coolant flow according to a reduced coolant flow rate in comparison with the nominal one). It results in a possible adjustment of the coolant flow rate inside the EGR cooler 30 from 0 to 100% of the nominal flow rate. Instead of an arrangement in which the exhaust gas bypasses the EGR cooler 30 not to be cooled down as it is currently done in existing solutions, the exhaust gas still flows through the EGR cooler 30. The coolant flow rate inside the EGR cooler 30 is adjusted depending on the requirements of the recirculated exhaust gas. It is therefore possible to switch from providing cooled exhaust gas or providing hot exhaust gas to the EGR mixer 20 only by actuating the EGR coolant valve 41 either in its open position or in its shut-off position.

In other words, the flow of the exhaust gas through the EGR cooler 30 is not impacted. It means that whatever the temperature of the exhaust gas at the outlet port of the EGR cooler 30 should be, the flow of the exhaust gas stays the same. The modification is operated at the coolant flow through the EGR cooler 30. Hot exhaust gas is achieved by limiting or even stopping the coolant flow through the EGR cooler 30. The main advantage is the safety of such an arrangement as the EGR coolant valve 41 is mounted in a part of the internal combustion engine where temperatures are not very high.

As depicted in FIG. 2, the EGR coolant valve 41 is mounted upstream of the EGR cooler 30. The EGR coolant valve 41 is mounted on the first duct 401. When the EGR coolant valve 41 is in its shut-off position, the coolant cannot reach the EGR cooler 30.

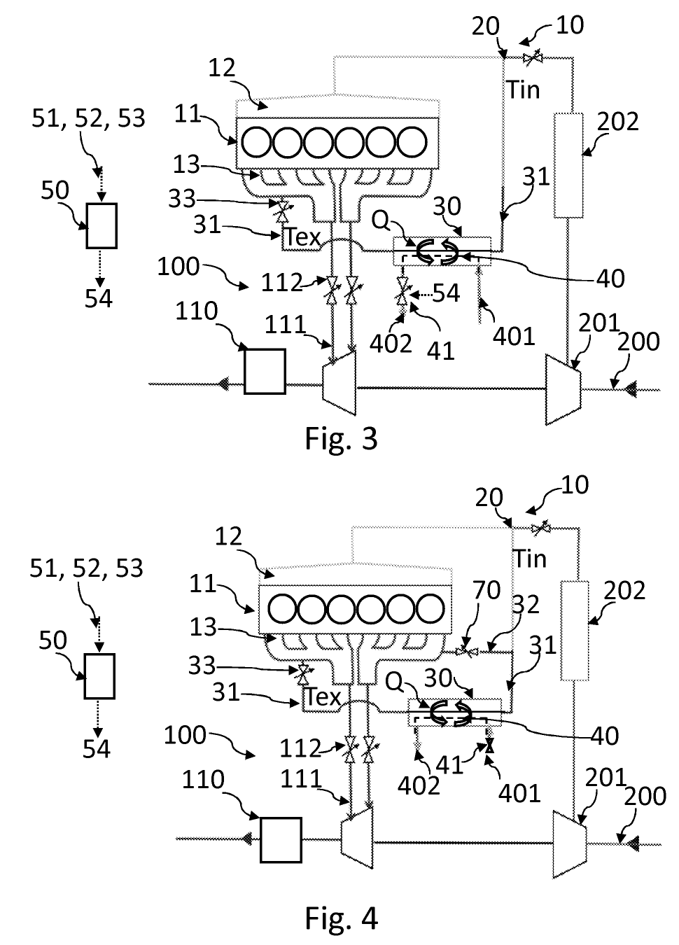

FIG. 3 is a schematic diagram showing an exemplary exhaust gas recirculation circuit 10 according to an example. The exhaust gas recirculation circuit 10 depicted in FIG. 3 is almost identical to the exhaust gas recirculation circuit of FIG. 2. The only difference is the positioning of the EGR coolant valve 41. In the exhaust gas recirculation circuit of FIG. 3, the EGR coolant valve 41 is mounted downstream of the EGR cooler 30. The EGR coolant valve 41 is mounted on the second duct 402. When the EGR coolant valve 41 is in its shut-off position, the coolant that had entered the EGR cooler 30 cannot leave it. No coolant flow can take place within the coolant circuit.

FIG. 4 is a schematic diagram showing an exemplary exhaust gas recirculation circuit according to an example. The exhaust gas recirculation circuit 10 depicted in FIG. 4 is almost identical to the exhaust gas recirculation circuit of FIG. 2 or FIG. 3. In the example depicted in FIG. 4, the exhaust gas recirculation circuit 10 further comprising a bypass pipe 32 intended to fluidically connect the exhaust manifold 13 to the EGR pipe downstream of the EGR cooler 30. The bypass pipe 32 forms a channel to fluidically connect the exhaust manifold 13 with the EGR mixer 30. The bypass pipe 32 allows a part of exhaust gas exiting from the cylinders and collected in the exhaust manifold 13 to be directly directed towards the EGR mixer 20. This bypass pipe 32 is a bypass of the EGR cooler 30. It enables to provide the EGR mixer 20 with hot recirculated exhaust gas

The exhaust gas recirculation circuit 10 further comprises a second EGR valve 70 configured to adjust the exhaust gas flow rate flowing in the bypass pipe 32. If the second EGR valve 70 is closed, no exhaust gas bypasses the EGR cooler 30 through the bypass pipe 32. If the second EGR valve 70 is open, exhaust gas bypasses the EGR cooler 32 through the bypass pipe 32.

The bypass line 32 and the second EGR valve 70 offer the option to use uncooled EGR if the second EGR valve 70 is open. Even if the EGR coolant valve 41 is the one element intended to operate to adapt the temperature of the recirculated exhaust gas through the EGR cooler 30, both the EGR coolant valve 41 and the second EGR valve 70 may be temporarily open at the same time, resulting in the provision of a large amount of hot exhaust gas.

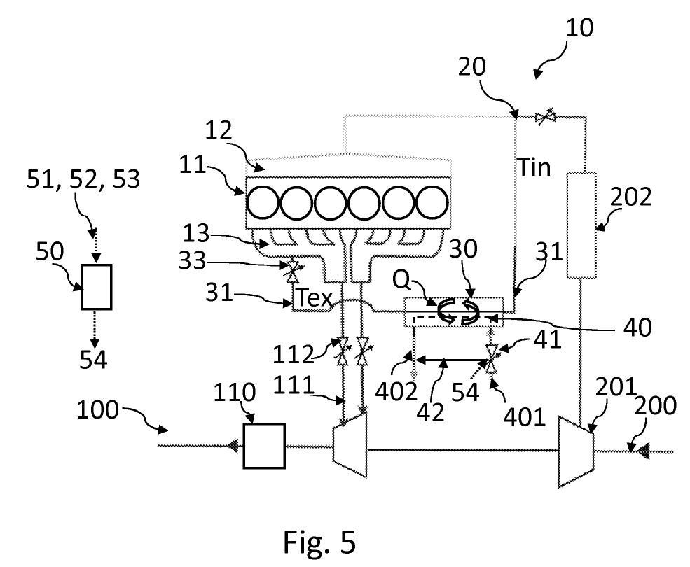

FIG. 5 is a schematic diagram showing an exemplary exhaust gas recirculation circuit according to an example. The exhaust gas recirculation circuit 10 depicted in FIG. 5 is almost identical to the exhaust gas recirculation circuit of FIG. 2 or FIG. 3. In the example depicted in FIG. 5, the coolant circuit 40 further comprises a bypass line 42 bypassing the EGR cooler 30. The bypass line 42 is a line fluidically connecting the first duct 401 to the second duct 402. In other words, the coolant flows in the coolant circuit but instead of being directed inside the EGR cooler 30, it is directed in the bypass line 42 and the second duct 402. That is to say that the coolant does not enter the EGR cooler 30.

The EGR coolant valve 41 is mounted so as to prevent the coolant flow inside the EGR cooler and to redirect the coolant flow in the bypass line 42. The EGR coolant valve 41 may be a set of two butterfly valves or a three-way valve connecting the first (or second) duct to the bypass line 42.

In some embodiments, the exhaust gas recirculation circuit 10 further comprises processing circuitry 50 configured to receive an input signal 51, 52, 53 and send a command 54 to the EGR coolant valve 41 to switch to the shut-off position if the input signal 51, 52, 53 is below a predefined threshold 61, 62, 63.

In a variant, the input signal 51 is a measured ambient air temperature, and the predefined threshold 61 is an air temperature threshold.

In another variant, the input signal 52 is a measured coolant temperature, and the predefined threshold 62 is a coolant temperature threshold.

In another variant, the input signal 53 is a measured intake manifold temperature, and the predefined threshold 63 is an intake manifold temperature threshold.

The communication between the processing circuitry 50 and the other elements of the internal combustion engine 11, especially the EGR coolant valve 41, is realized through sensor signals and actuator commands. Particularly, the transmission of signals and commands to and from the processing circuitry 50 is performed by known communication means, such as wired connection, wireless connection, local area network bus, serial peripheral interface bus, etc. For these purposes, processing circuitry 50 may comprise at least one processor. Under the term processor, it should be understood at least one of a processor, microprocessor, Application Specific Integrated Circuit (also known under its acronym ASIC), electronic circuit, central processing unit. The processing circuitry 50 may comprise, or have access to, at least one memory component (read only, programmable read only, random access, hard drive, etc.) able to store machine readable instructions accessible by the processor to provide the desired functionality.

Further to instructions stored on the memory, the processing circuitry sends to the ambient air temperature sensor the command to measure ambient air temperature. The ambient air temperature sensor provides the processing circuitry with the measured ambient air temperature which is the input signal 51. The processing circuitry compares this input signal 51 with the predefined threshold 61 which is an air temperature threshold, for example -10°C. If the input signal 51, i.e. the measured ambient air temperature is lower than the threshold (-10°C), it means that cold conditions are met. In order to avoid ice formation inside the EGR pipe 31 and/or inside the EGR cooler 30, the processing circuitry 50 sends a command 54 to the EGR coolant valve 41 to switch to the shut-off position. Following this, coolant does not flow anymore in the EGR cooler 30, the exhaust gas flowing through the EGR pipe 31 and the EGR cooler 30 is hot, thereby preventing ice formation.

The same applies to the other parameters amongst the measured coolant temperature and the measured intake manifold temperature.

Once the EGR coolant valve 41 is in its shut-off position, the processing circuitry 50 may further send commands to the sensors to proceed with measures. Once the measurements, i.e. the input signals for the processing circuitry 50, are above the corresponding threshold, the processing circuitry 50 sends a command 54 to the EGR coolant valve 41 to switch to the open position. Coolant can flow again through the EGR cooler 30. The exhaust gas is cooled down in the EGR cooler 30 before being provided to the EGR mixer 20.

The disclosed technology also concerns an internal combustion engine 11 comprising an inlet manifold 12, an exhaust manifold 13 for collecting exhaust gas from the combustion in the internal combustion engine 11, and an exhaust system 100 comprising: the exhaust gas recirculation circuit 10, the exhaust aftertreatment system 110 intended to process pollutants contained in the exhaust gas, the exhaust line 111 fluidically connecting the exhaust manifold 13 to the exhaust aftertreatment system 110.

The internal combustion engine 11 was described in relation with FIG. 2.

The internal combustion engine 11 may further comprise an ambient air temperature sensor configured to measure ambient air temperature, and/or a coolant temperature sensor configured to measure a coolant temperature in the coolant circuit, and/or an intake manifold temperature sensor configured to measure a temperature inside the intake manifold.

Example 1: An exhaust gas recirculation circuit 10 of an internal combustion engine 11 comprising an inlet manifold 12 and an exhaust manifold 13 for collecting exhaust gas from the combustion in the internal combustion engine 11, said exhaust gas recirculation circuit 10 being configured to evolve between a flowing configuration, in which exhaust gas is allowed to flow through it, and a closed configuration, in which the exhaust gas flow through it is prevented, and vice versa, said exhaust gas recirculation circuit 10 comprising: An EGR mixer 20 intended to be fluidically connected to the inlet manifold 12, and configured to be supplied with exhaust gas and air, and to mix them,

An EGR pipe 31 intended to fluidically connect the EGR mixer 20 to the exhaust manifold 13, A first EGR valve 33 configured to adjust the exhaust gas flow rate flowing from the exhaust manifold 13 to the EGR mixer 20 in the flowing configuration and to prevent the exhaust gas flow to the EGR mixer 20 in the closed configuration, An EGR cooler 30 mounted in the EGR pipe 31, intended to be supplied with exhaust gas at an exhaust temperature Tex from the exhaust manifold 13 and to deliver exhaust gas at a target inlet temperature Tin, A coolant circuit 40 in which a coolant is intended to flow, said coolant circuit passing through the EGR cooler 30, so as to operate a heat exchange Q between the exhaust gas and the coolant, An EGR coolant valve 41 mounted in the coolant circuit 40, said EGR coolant valve 41 being configured to switch between an open position in which coolant can flow through the EGR cooler 30 to a shut-off position in which coolant is prevented from flowing through the EGR cooler 30.

Example 2: The exhaust gas recirculation circuit 10 of Example 1, wherein the EGR coolant valve 41 is mounted upstream of the EGR cooler 30.

Example 3: The exhaust gas recirculation circuit 10 of Example 1, wherein the EGR coolant valve 41 is mounted downstream of the EGR cooler 30.

Example 4: The exhaust gas recirculation circuit 10 of any of Examples 1 to 3, wherein the coolant circuit 40 comprises a bypass line 42 bypassing the EGR cooler 30.

Example 5: The exhaust gas recirculation circuit 10 of any of Examples 1 to 4, further comprising processing circuitry 50 configured to receive an input signal 51, 52, 53 and send a command 54 to the EGR coolant valve 41 to switch to the shut-off position if the input signal 51, 52, 53 is below a predefined threshold 61, 62, 63.

Example 6: The exhaust gas recirculation circuit 10 of Example 5, wherein the input signal 51 is a measured ambient air temperature, and the predefined threshold 61 is an air temperature threshold.

Example 7: The exhaust gas recirculation circuit 10 of Example 5 or 6, wherein the input signal 52 is a measured coolant temperature, and the predefined threshold 62 is a coolant temperature threshold.

Example 8: The exhaust gas recirculation circuit 10 of any of Examples 5 to 7, wherein the input signal 53 is a measured intake manifold temperature, and the predefined threshold 63 is an intake manifold temperature threshold.

Example 9: The exhaust gas recirculation circuit 10 of any of Examples 5 to 8, further comprising a bypass pipe 32 intended to fluidically connect the exhaust manifold 13 to the EGR pipe downstream of the EGR cooler 30, and a second EGR valve 70 configured to adjust the exhaust gas flow rate flowing in the bypass pipe 32.

Example 10: An internal combustion engine 11 comprising an inlet manifold 12, an exhaust manifold 13 for collecting exhaust gas from the combustion in the internal combustion engine 11, and an exhaust system 100 comprising: an exhaust gas recirculation circuit 10 of any one of Examples 1 to 9, an exhaust aftertreatment system 110 intended to process pollutants contained in the exhaust gas, an exhaust line 111 fluidically connecting the exhaust manifold 13 to the exhaust aftertreatment system 110.

Example 11: The internal combustion engine 11 of Example 10, further comprising an ambient air temperature sensor configured to measure ambient air temperature.

Example 12: The internal combustion engine 11 of Example 10 or 11, further comprising a coolant temperature sensor configured to measure a coolant temperature in the coolant circuit.

Example 13: The internal combustion engine 11 of any of Examples 10 to 12, further comprising an intake manifold temperature sensor configured to measure a temperature inside the intake manifold.

Example 14: A vehicle 1 comprising an internal combustion engine 11 according to any one of Examples 10 to 13.

The terminology used herein is for the purpose of describing particular aspects only and is not intended to be limiting of the disclosure. As used herein, the singular forms "a," "an," and "the" are intended to include the plural forms as well, unless the context clearly indicates otherwise. As used herein, the term "and/or" includes any and all combinations of one or more of the associated listed items. It will be further understood that the terms "comprises," "comprising," "includes," and/or "including" when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as "below" or "above" or "upper" or "lower" or "horizontal" or "vertical" may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being "connected" or "coupled" to another element, it can be directly connected or coupled to the other element, or intervening elements may be present. In contrast, when an element is referred to as being "directly connected" or "directly coupled" to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

What is claimed is:

1. An exhaust gas recirculation circuit of an internal combustion engine comprising an inlet manifold and an exhaust manifold for collecting exhaust gas from the combustion in the internal combustion engine, said exhaust gas recirculation circuit being configured to evolve between a flowing configuration, in which exhaust gas is allowed to flow through it, and a closed configuration, in which the exhaust gas flow through it is prevented, and vice versa, said exhaust gas recirculation circuit comprising:
an exhaust gas recirculation (EGR) mixer intended to be fluidically connected to the inlet manifold, and configured to be supplied with exhaust gas and air, and to mix them,
an EGR pipe intended to fluidically connect the EGR mixer to the exhaust manifold,
a first EGR valve configured to adjust the exhaust gas flow rate flowing from the exhaust manifold to the EGR mixer in the flowing configuration and to prevent the exhaust gas flow to the EGR mixer in the closed configuration,
an EGR cooler mounted in the EGR pipe, intended to be supplied with exhaust gas at an exhaust temperature (Tex) from the exhaust manifold and to deliver exhaust gas at a target inlet temperature (Tin),
a coolant circuit in which a coolant is intended to flow, said coolant circuit passing through the EGR cooler, so as to operate a heat exchange between the exhaust gas and the coolant, and
an EGR coolant valve mounted in the coolant circuit, said EGR coolant valve being configured to switch between an open position in which coolant can flow through the EGR cooler to a shut-off position in which coolant is prevented from flowing through the EGR cooler.

2. The exhaust gas recirculation circuit of claim 1, wherein the EGR coolant valve is mounted upstream of the EGR cooler.

3. The exhaust gas recirculation circuit of claim 1, wherein the EGR coolant valve is mounted downstream of the EGR cooler.

4. The exhaust gas recirculation circuit of claim 1, wherein the coolant circuit comprises a bypass line bypassing the EGR cooler.

5. The exhaust gas recirculation circuit of claim 1, further comprising processing circuitry configured to receive an input signal and send a command to the EGR coolant valve to switch to the shut-off position if the input signal is below a predefined threshold.

6. The exhaust gas recirculation circuit of claim 5, wherein the input signal is a measured ambient air temperature, and the predefined threshold is an air temperature threshold.

7. The exhaust gas recirculation circuit of claim 5, wherein the input signal is a measured coolant temperature, and the predefined threshold is a coolant temperature threshold.

8. The exhaust gas recirculation circuit of claim 5, wherein the input signal is a measured intake manifold temperature, and the predefined threshold is an intake manifold temperature threshold.

9. The exhaust gas recirculation circuit of claim 5, further comprising a bypass pipe intended to fluidically connect the exhaust manifold to the EGR pipe downstream of the EGR cooler, and a second EGR valve configured to adjust the exhaust gas flow rate flowing in the bypass pipe.

10. An internal combustion engine comprising an inlet manifold, an exhaust manifold for collecting exhaust gas from the combustion in the internal combustion engine, and an exhaust system comprising:
an exhaust gas recirculation circuit of claim 1,
an exhaust aftertreatment system intended to process pollutants contained in the exhaust gas, and
an exhaust line fluidically connecting the exhaust manifold to the exhaust aftertreatment system.

11. The internal combustion engine of claim 10, further comprising an ambient air temperature sensor configured to measure ambient air temperature.

12. The internal combustion engine of claim 10, further comprising a coolant temperature sensor configured to measure a coolant temperature in the coolant circuit.

13. The internal combustion engine of claim 10, further comprising an intake manifold temperature sensor configured to measure a temperature inside the intake manifold.

14. A vehicle comprising an internal combustion engine according to claim 10.
